(19) United States
(12) Patent Application Publication
(10) Pub. No.: US 2008/0104120 A1
(43) Pub. Date: May 1, 2008

(54) DATA PROCESSING APPARATUS, DATA STORAGE APPARATUS, DATA PROCESSING SYSTEM, DATA PROCESSING METHOD, AND DATA STORING METHOD

(75) Inventor: Keito FUKUSHIMA, Mitaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/923,127

(22) Filed: Oct. 24, 2007

(30) Foreign Application Priority Data
Oct. 27, 2006 (JP) 2006-292829

(51) Int. Cl. G06F 17/30

(52) U.S. Cl. 707/104.1

(57) ABSTRACT

An electronic camera serving as a data processing apparatus includes an image pickup section which images a subject and generates image data thereof, a recording medium which records the generated image data through a recording medium interface, a CPU which executes a control program read from a flash memory and controls constituent elements of the electronic camera, an operation section which provides instructions concerning operation of the electronic camera, and a display section which displays image data and the like read from the recording medium through the recording medium interface.

### CROSS-REFERENCE TO RELATED APPLICATIONS

This application is based upon and claims the benefit of priority from prior Japanese Patent Application No. 2006-292829, filed Oct. 27, 2006, the entire contents of which are incorporated herein by reference.

### BACKGROUND OF THE INVENTION

1. Field of the Invention

The present invention relates to a data processing apparatus, a data storage apparatus, a data processing system, a data processing method, and a data storing method.

2. Description of the Related Art

Generally, images taken by electronic cameras are recorded on storage media (flash memory or the like) detachably attached to the electronic cameras. Electronic media are rewritable and can be used repeatedly, and have an increased recording capacity as a result of advances in semiconductor technology. Therefore, the number of images which can be taken for one storage medium has dramatically increased in comparison with the number of images which can be taken with film cameras. These images are recorded and stored in data storage apparatuses or data storage media having larger capacity, such as hard disks, CD-Rs, CD-RWs, and OVDs, through personal computers.

In the prior art, images are grouped based on categories and keywords associated with the images, by using image management software executed on personal computers. Further, when an image is retrieved, a desired image can be easily retrieved, by narrowing a search to a relevant group based on the keywords and categories.

Further, for example, Jpn. Pat. Appln. KOKAI Pub. No. 2000-341636 discloses an invention in which an image taken by a digital camera is associated with a specific category name by a simple operation of the digital camera, to ease classification and organization of taken images to be performed later on a personal computer.

### BRIEF SUMMARY OF THE INVENTION

A data processing apparatus according to a first aspect of the present invention manages a plurality of content data items as one or more groups, and comprises:

an ID assigning section which provides an identifier (ID) to the group; and

a group management data generating section which generates a group management data item including at least an association information item between the content data items and the group and the ID.

A data storage apparatus according to a second aspect of the present invention obtains and stores content data items in groups from a data processing apparatus managing a plurality of data items as one or more groups, and comprises:

a storing section which stores data;

an ID obtaining section which obtains an ID of a group to be obtained from the data processing apparatus;

a determining section which compares the ID obtained by the ID obtaining section with IDs of groups stored in the storing section, and determines whether same group as the group to be obtained from the data processing apparatus is stored in the storing section; and

a control section which controls obtaining of the group from the data processing apparatus and storing of the group in the storing section, according to a result of determination by the determining section.

A data processing system according to a third aspect of the present invention comprises:

a data processing apparatus which manages a plurality of content data items as one or more groups; and

a data storage apparatus which obtains and stores content data items in groups from the data processing apparatus,

wherein the data processing apparatus includes:

an ID assigning section which assigns an ID to the group, and

a group management data generating section which generates a management data item including at least association information between the content data items and the group and the ID; and

the data storage apparatus includes:

a storing section which stores data;

an ID obtaining section which obtains an ID of a group to be obtained from the data processing apparatus;

a determining section which compares the ID obtained by the ID obtaining section with IDs of groups stored in the storing section, and determines whether same group as the group to be obtained from the data processing apparatus is stored in the storing section; and

a control section which controls obtaining of the group from the data processing apparatus and storing of the group in the storing section, according to a result of determination by the determining section.

A data processing method according to a fourth aspect of the present invention allows a computer to manage a plurality of content data items as one or more groups, and comprises:

causing the computer to generate IDs for the respective groups; and

causing the computer to generate group management data items including at least association information between the content data items and the relevant group, and the respective IDs.

A data storing method according to a fifth embodiment of the present invention allows a computer to obtain and store content data items in groups from a data processing apparatus managing a plurality of content data items as one or more groups, and comprises:

causing the computer to obtain an ID of a group to be obtained from the data processing apparatus;

causing the computer to compare the ID with IDs of groups stored in the storing section which the computer manages, and determine whether same group as the group to be obtained from the data processing apparatus is stored in the storing section; and

causing the computer to control obtaining of the group from the data processing apparatus and storing of the group in the storing section, according to a result of determination.

### BRIEF DESCRIPTION OF THE SEVERAL VIEWS OF THE DRAWING

FIG. 1 is a schematic block diagram of an electronic camera serving as a data processing apparatus according to a first embodiment of the present invention.

FIG. 2 is a flowchart of a data processing program carried out on the electronic camera according to the first embodiment.

FIG. 3A is a diagram illustrating a data recording structure, in which no group management data is generated, in a recording medium of the electronic camera according to the first embodiment.

FIG. 3B is a diagram illustrating a data recording structure, in which a group management data item is generated, in the recording medium of the electronic camera according to the first embodiment.

FIG. 4A is a diagram illustrating an example of description of a group management data item, which does not include image information, in the recording medium of the electronic camera according to the first embodiment.

FIG. 4B is a diagram illustrating an example of description of a group management data item, in which image information is additionally written, in the recording medium of the electronic camera according to the first embodiment.

FIG. 5 is a schematic block diagram of a data storing apparatus according to a second embodiment of the present invention, which is connected to the electronic camera serving as the data processing apparatus according to the first embodiment.

FIG. 6 is a flowchart of a data storing program carried out on the data storing apparatus according to the second embodiment.

FIG. 7 is a diagram illustrating a data recording structure recorded on the recording medium of the electronic camera.

FIG. 8A is a diagram illustrating an example of description of a group management data item (GRP0001.XML) illustrated in FIG. 7.

FIG. 8B is a diagram illustrating an example of description of another group management data item (GRP0002.XML) illustrated in FIG. 7.

FIG. 9 is a diagram illustrating a data recording is structure of a data recording medium of the data storing apparatus according to the second embodiment, before the data storing apparatus is operated.

FIG. 10 is a diagram illustrating an example of description of the group management data (GRP0001.XML) illustrated in FIG. 9.

FIG. 11 is a diagram illustrating a data recording structure of the data recording medium of the data storing apparatus according to the second embodiment, after the data storing apparatus is operated.

FIG. 12A is a diagram illustrating an example of description of a group management data item (GRP0001.XML) illustrated in FIG. 11.

FIG. 12B is a diagram illustrating an example of description of another group management data item (GRP0002.XML) illustrated in FIG. 11.

### DETAILED DESCRIPTION OF THE INVENTION

A best mode for carrying out the present invention is explained below with reference to drawings.

### First Embodiment

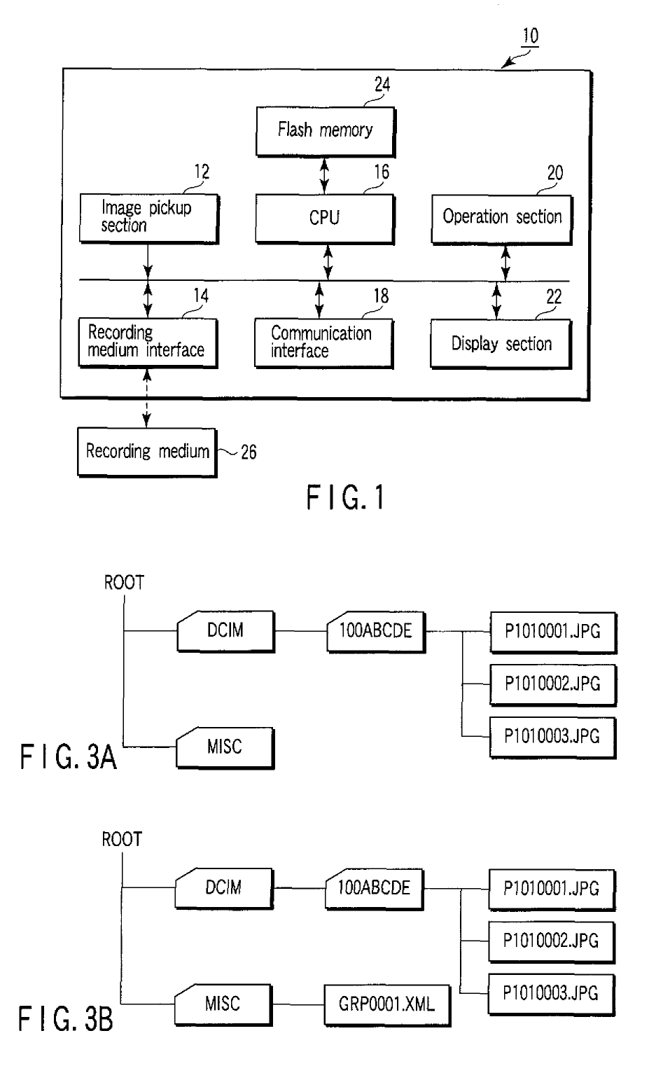

FIG. 1 is a schematic block diagram of an electronic camera 10 serving as a data processing apparatus according to a first embodiment of the present invention.

The electronic camera 10 comprises an image pickup section 12, a recording medium interface 14, a CPU 16, a communication interface 18, an operation section 20, a display section 22, and a flash memory 24.

The CPU 16 reads and carries out a control program, which is stored in the flash memory 24 and includes a data processing program described in detail later, and thereby controls operations of the sections of the electronic camera 10. The image pickup section 12 shoots a subject, generates an image signal, and generates image data by performing various image processing. The image data generated by the image pickup section 12 is recorded on the recording medium 26 through the recording medium interface 14. A flash memory which can be detachably attached to the electronic camera 10, or a hard disk fixed to the electronic camera 10 is used as the recording medium 26. The operation section 20 has an operation switch to input instructions concerning the operation of the electronic camera 10 and the like. The display section 22 displays image data read from the recording medium 26 through the recording medium interface 14, or a user interface screen picture, etc.

The communication interface 18 performs transmission and reception of data such as taken images with external apparatuses not shown. The route used for transmission and reception of information is not limited to wired communication using cables or the like, but also includes wireless communication such as infrared communication.

Next, operation of the electronic camera 10 having the above structure is explained with reference to drawing.

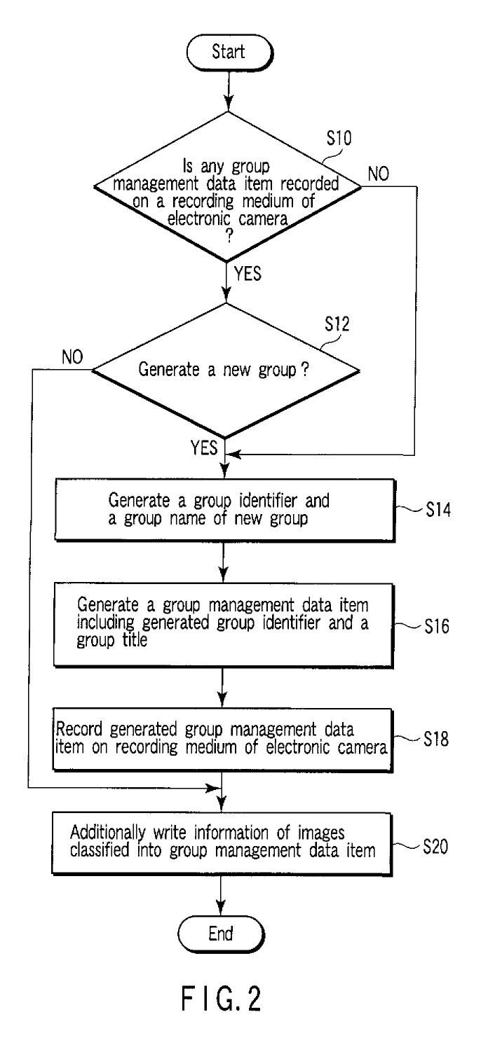

FIG. 2 is a flowchart of a data processing program which classifies images recorded on the recording medium 26 of the electronic camera 10 into groups. FIG. 3A illustrates a data recording structure of the recording medium 26. The data recording structure is compliant with DCF (Design rule for Camera File System), which is a digital camera file system. For example, FIG. 3A illustrates the state where three image data items (P1010001.JPG, P1010002.JPG. and P1010003.JPG) are recorded and no groups are formed.

In this state, when the user selects at least one image to be classified and designates grouping by operating the operation section 20, the CPU 16 determines, as a first step, whether any group management data is recorded on the recording medium 26 of the electronic camera 10 (step S10). When there are no groups in this step, the CPU 16 branches step S10 to NO, and goes to processing to prepare a new group management data item.

On the other hand, when step S10 is YES, the CPU 16 displays a list of recorded groups on the display section 22, and receives selection of a group into which the image is classified. When the user determines that the existing groups are not appropriate (for example, the image to be classified does not match the categories of the existing groups), the CPU 16 generates a new group. When a new group is generated, the user operates the operation section 20 in accordance with the screen display of the display section 22 of the electronic camera 10, and thereby provides an instruction to generate a new group in the electronic camera 10. The CPU 16 determines whether such an instruction to generate a new group is received or not (step S12).

When a new group is generated as a result of branching step S12 to YES or branching step S10 to NO, the CPU 16 generates a group identifier corresponding to the new group. Simultaneously, the CPU 16 receives input of a character string indicating a group name by user's operation of the operation section 20, and generates a group name of the new group (step S14). A group name is not always necessary. However, in consideration of convenience of the user in image search, it is preferable that at least any group name is automatically generated as described below even when the user does not input a character string. Thereafter, the CPU 16 generates a new group management data item (Step S16). The group management data item includes the group identifier and the group name for the new group which are generated in step S14. The CPU 16 records the generated group management data item in the recording medium 26 through the recording medium interface 14 (Step S18). FIG. 3B illustrates a data recording structure of the recording medium 26, in which the new group management data item (GRP0001.XML) generated as described above is recorded.

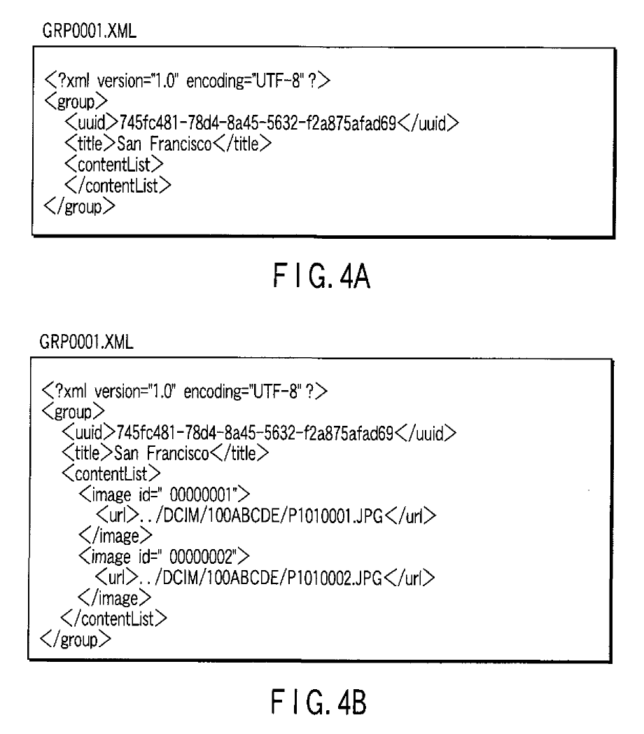

FIG. 4A illustrates contents of the group management data item (GRP0001.XML). Although the group management data item is described in Extensible Markup Language (XML) in this embodiment, it is not limited to XML but can be described by using another language.

Although a data recording structure compliant with DCF is adopted in this embodiment, the data structure is not necessarily compliant with DCF.

In the example shown in FIG. 4A, the group identifier (id) generated in step S14 is a value of a uuid element (745fc481-78d4-8a45-5632-f2a875afad69) using the Universally Unique Identifier (UUID) standard, the technical specification of which is published by the Internet Engineering Task Force (IETF) and which is described in RFC4122. A group identifier is set for each group, and is required to be unique, not overlapping group identifiers of other groups. For example, it is possible to use an identifier generated by using the manufacturer's name, product name, serial number, date, and time. In this case, supposing that the manufacturer's name is “SomeCompany”, the product name is “SomeProduct”, the serial number is “0123456789”, and the date and time is 00:00:00 of Jan. 1, 2006, the identifier “SomeCompany-SomeProduct-0123456789-200601010000) can be used.

Further, the group name generated in step S14 is described as the value (San Francisco) of the title element, in the example of FIG. 4A. The group name is a group title (keyword, or category name) indicating the group. The group name is a character string input by the user by operating the operation section 20 when the group name was generated. If the electronic camera 10 does not have input means for inputting such a character string, it may be configured to automatically generate a group name formed of “specific characters+number” by the data processing program, such as “GROUP 1” and “GROUP 2”. In this case, the “number” is increased by 1 each time a new group is generated.

The part of “content List” in the group management data item of FIG. 4A, in which values of contentList elements are to be put, is blank. This is because no images are classified into the group management data item of FIG. 4A. Information of images classified into the group is described as the value of the contentList element.

When the group management data item is generated as described above, information of designated images is added to the group management data item (Step S20). If the flow is branched to NO in step S12, the user requests classification of images into an existing group, without generating a new group. In this case, information of classified images is added to a group management data item corresponding to an existing group designated by the user.

For example, when images P1010001.JPG and P1010002.JPG are classified into the group “San Francisco”, the corresponding group management data item (GRPT0001.XML) is as illustrated in FIG. 4B. In this case, the description of the group management data item is description obtained by adding image information to the group management data item illustrated in FIG. 4A. Therefore, the value of uuid element and the value of the title element described in FIG. 4B are the same as the respective corresponding values described in FIG. 4A.

The value of the contentList element in FIG. 4B is a list of image information items classified into the group. The subsidiary element “image” of the contentList element is information of images classified into the group. The ID attribute of the “image” element is an image identifier which identifies an image classified into the group, and is a unique value in the contentList element. The value (../DCIM/100ABCDE/P1010001.JPG, etc) of the subsidiary element “url” of the “image” element indicates a recording position of the image. Further, as image information, the date of shooting, and/or the place of shooting may be recorded as well as the recording position of the image in the recording medium 26. Although only the “image” is used as the subsidiary element of the contentList element in the above embodiment, information of subsidiary elements other than “image” (image) can be described, by using “video” (moving image) and “audio” (music) and the like.

In the above embodiment, the user instructs the electronic camera 10 to generate a group. However, as described below, it is possible to adopt an embodiment in which the electronic camera 10 automatically generates a group, and automatically classifies a taken image into a group for each shooting operation.

In the embodiment, the electronic camera 10 is provided with various information by functions included in the electronic camera 10. For example, although not shown, if the electronic camera 10 has an internal clock, the electronic camera 10 is provided with the date and time information. If the electronic camera 10 has a GPS function, the electronic camera is provided with position information (latitude, longitude, and altitude). These information items are updated momently when provided to the electronic camera 10. In the embodiment, when these information items are updated exceeding a certain range, a new group is generated. This processing corresponds to the processing in which the electronic camera 10 automatically performs steps S12, S14, S16, and S18 in the flow of FIG. 2 on the basis of the provided information.

In the case of using the date and time information mentioned above as an example, supposing that month information is updated from May 2006 to June 2006, a new group “June 2006” is generated, and images taken thereafter are classified into the group until the month information is updated next. As a result, images can be automatically grouped according to month. As a matter of course, the user can determine how to use the date and time information for classification of images, by providing an instruction for setting it in the electronic camera 10. The method of setting how to use the date and time information for classification of images is not limited to the example described herein.

Further, in the case of using the position information mentioned above as an example, supposing that the position information is updated to position information indicating another prefecture, for example, from the position information indicating Tokyo to the position information indicating Kanagawa, a new group “Kanagawa” is generated (if the group “Kanagawa” has not yet been generated). Thereafter, until the position information is updated to position information indicating another prefecture, taken images are classified into the group “Kanagawa”. As a result, images can be grouped according to the shooting place (according to prefectures, in this example). As a matter of course, the user can determine how to use the position information for classification of images, by providing an instruction for setting it in the electronic camera 10. The method of setting how to use the position information for classification of images is not limited to the example described herein.

Further, if the electronic camera 10 has user information (such as the photographer's name and configuration settings) as other information and it is possible to change the user information each time the user who uses the electronic camera 10 changes, a new group is generated (if there is no corresponding group) when the user information is changed. Then, images taken thereafter are classified into this group until the user information is changed next. As a result, images can be grouped according to the user. As a matter of course, the user can determine how to use the user information for classification of images, by providing an instruction for setting it in the electronic camera 10. The method of setting how to use the user information for classification of images is not limited to the example described herein.

Further, all the images recorded on the recording medium 26 can be dealt with as one group, and thus images can be grouped in a unit corresponding to a roll of film for silver-halide film cameras. In this case, a new group is generated when no group management data exists on the recording medium 26, or when the recording medium 26 is formatted. Also in this case, the user can determine whether to perform grouping or not by providing an instruction to the electronic camera 10. Conversely, even when no group management data exists on the recording medium 26 or the recording medium 26 is formatted, it is possible to classify images into the same group as before, by generating a new group associated with the same group identifier as described above.

### Second Embodiment

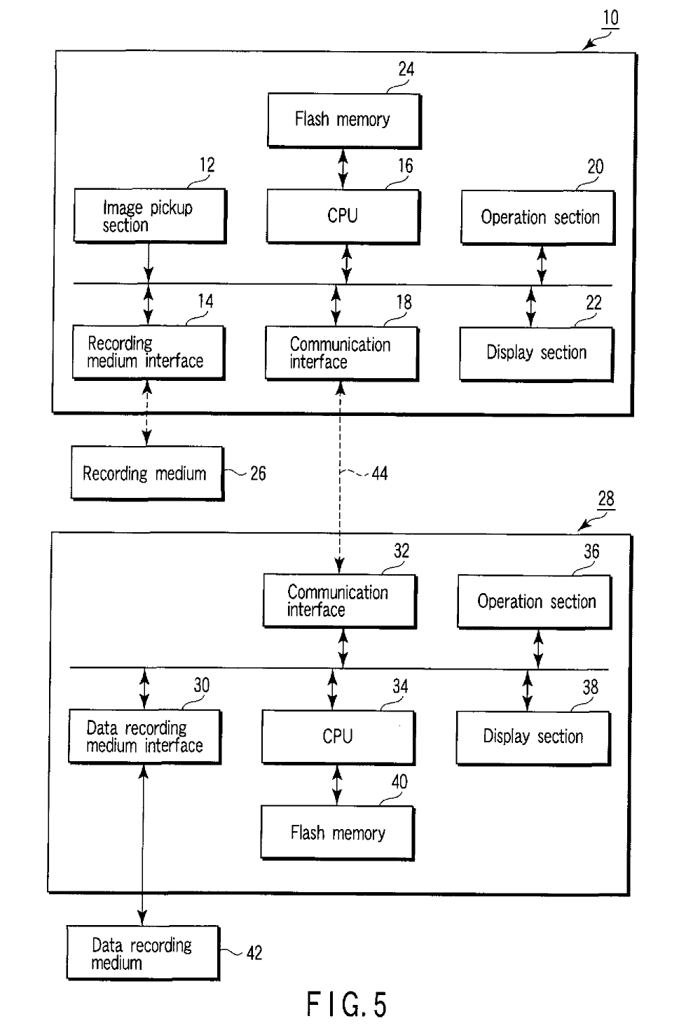

FIG. 5 is a schematic block diagram of a structure, in which a data storage apparatus 28 according to the second embodiment of the present invention is connected to the electronic camera 10 serving as the data processing apparatus. The data storage apparatus 28 comprises a data recording medium interface 30, a communication interface 32, a CPU 34, an operation section 36, a display section 38, and a flash memory 40. The data storage apparatus 28 and the electronic camera 10 are connected by a communication line 44.

The CPU 34 reads and runs a control program, which is recorded in the flash memory 40 and includes a data storing program detailed below, and thereby controls operations of constituent elements of the data storage apparatus 28. Data such as taken images which are transmitted to and received from the electronic camera 10 are recorded on the data recording medium 42, which is connected with the data recording medium interface 30, through the communication interface 32. As the data recording medium 42, used is a flash memory, a CD-R, a CD-RW, or a DVD detachably connected to the data storage apparatus 28, or a hard disk held in the data storage apparatus 28. The operation section 36 has a keyboard, a mouse, or a switch to input instructions concerning operation of the data storage apparatus 28. The display section 38 displays image data read from the data recording medium 42 through the data recording medium interface 30, and/or a user interface screen picture.

A preferable embodiment of the data storage apparatus 28 is a personal computer. However, the data storage apparatus 28 is not required to have many operation sections 36 or the display section 38 included in general personal computers. The data storage apparatus 28 may be a portable storage dedicated to data recording, as long as the data storage apparatus 28 includes communication interface 32 to perform data transmission and reception with the electronic camera 10, data recording medium interface 30 to record the transmitted and received data on the data recording medium 42, and CPU 34 to control operation of the constituent elements of the data storage apparatus 28.

Next, operation of the data storage apparatus 28 according to the second embodiment of the present invention is explained together with a data recording method thereof, with reference to FIG. 5. When the electronic camera 10 is connected to the data storage apparatus 28 by the communication line 44 as illustrated in FIG. 5, the data storage apparatus 28 of the second embodiment detects connection of the electronic camera 10, and starts the control program (hereinafter referred to as “data storing program”) recorded in the flash memory 40. However, as a matter of course, it is possible to adopt an embodiment in which connection of the electronic camera 10 is not automatically detected, and the user provides an instruction to start the data storing program by using the operation section 36.

Further, the communication line 44 may be a cable communication link such as USB (Universal Serial Bus) or IEEE 1394 (Institute of Electrical and Electronic Engineers 1394), a wireless communication link such as a wireless LAN (Local Area Network), or a network communication link such as the Internet.

The data storing program is automatically started after detection of the electronic camera 10, or started by a user's instruction provided by operating the operation section 36. Thereby, data such as images recorded on the recording medium 26 of the electronic camera 10 are recorded on the data recording medium 42 of the data storage apparatus 28.

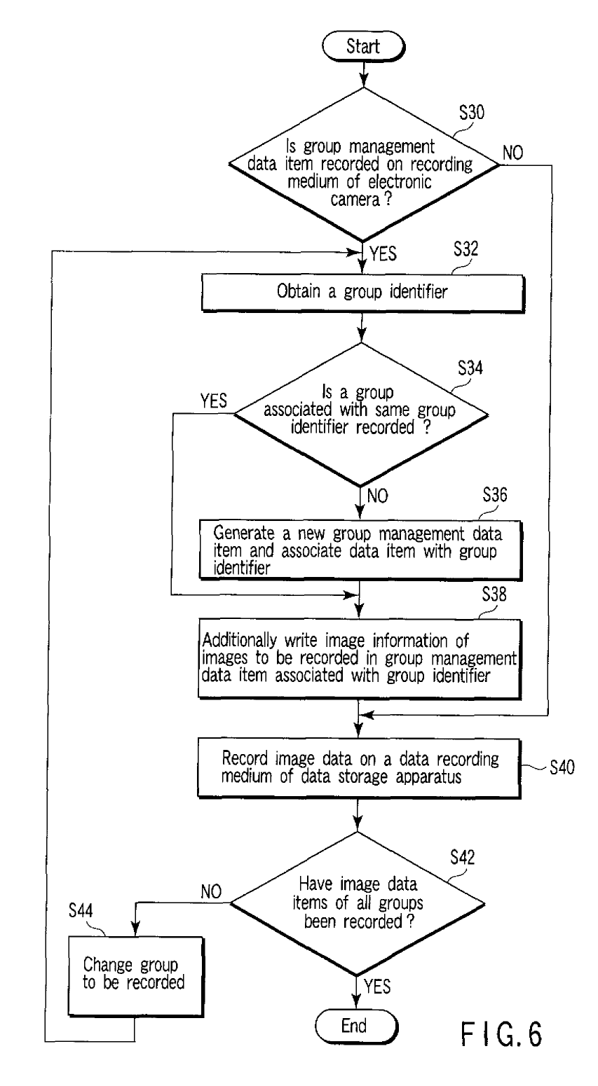

FIG. 6 is a flowchart of the data storing program run by the CPU 34 of the data storage apparatus 28 connected to the electronic camera 10.

First, the flow is started, and it is determined whether any group management data item is recorded on the recording medium 26 of the electronic camera 10 (Step S30). When it is determined that a group management data item is recorded (branched to YES in Step S30), a group identifier is obtained from the group management data item (Step S32), and it is determined whether the group associated with the group identifier has already been recorded on the data recording medium 42 of the data storage apparatus 28 (Step S34). When it is determined that the group associated with the group identifier is not recorded (branched to NO in Step S34), a new group management data item is generated in the data recording medium 42 of the data storage apparatus 28, and associated with the group identifier (specifically, the obtained group identifier is described in the newly generated group management data item) (Step S36). Thereafter, information of images to be recorded is added to the group management data item associated with the group identifier (Step S38).

When the flow is branched to YES in step S34, a group management data item associated with the group identifier already exists. Therefore, step S38 is executed, without executing step S36.

Next, image data corresponding to the group and recorded on the recording medium 26 of the electronic camera 10 is recorded on the data recording medium 42 of the data storage apparatus 28 (Step S40). If no group management data item is recorded on the recording medium 26 of the electronic camera 10 in step S30 (when branched to NO in Step S30), no group management data is generated in the data recording medium 42 of the data storage apparatus 28 as described above, and the flow goes to step S40. As a result, image data recorded on the recording medium 26 of the electronic camera 10 is recorded on the data recording medium 42 of the data storage apparatus 28.

Next, it is determined whether image data items of all the groups recorded on the recording medium 26 of the electronic camera 10 have been recorded on the data recording medium 42 of the data storage apparatus 28 (Step S42). The flow is branched to YES of step S42, the serial operation of the data storage apparatus is ended. However, if image data items of all the groups recorded on the recording medium 26 of the electronic camera 10 have not been recorded (NO of Step S42), the group of the recording medium 26 of the electronic camera 10 is changed (Step S44), the flow goes back to step S32, and the above processing is repeated for another group. As described above, when image data items of all the groups recorded on the recording medium 26 of the electronic camera 10 are recorded on the data recording medium 42 of the data storage apparatus 28, the data storage apparatus 28 ends the processing.

As described above, the data storage apparatus 28 identifies the group based on the group identifier. Therefore, for example, even when the same group name is used for groups of different data processing apparatuses, the data storage apparatus 28 can manage them as different groups. Further, the data storage apparatus 28 can identify a group even when the user edits the group name thereof.

The following is an explanation of an example of operation of the data storage apparatus 28 explained above by using the flowchart of FIG. 6.

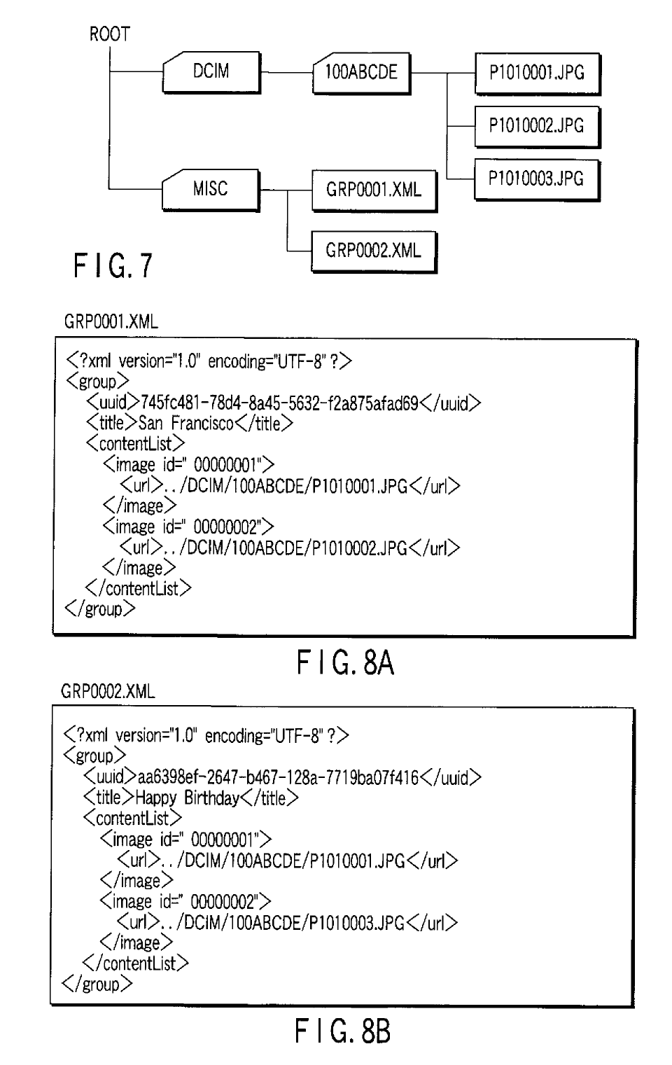

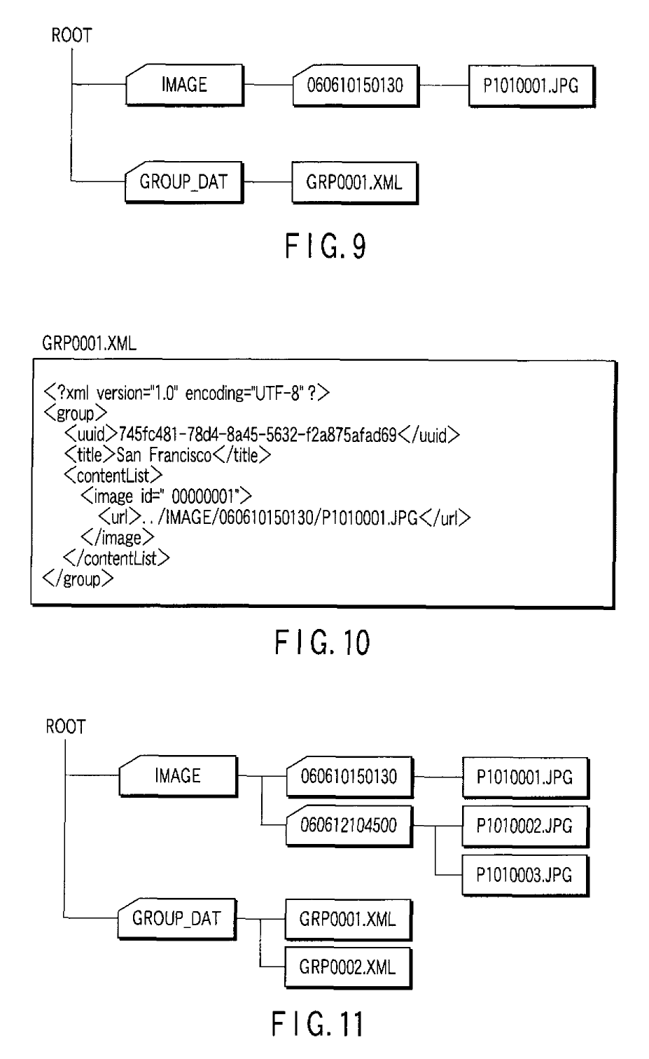

FIG. 7 illustrates a data recording structure recorded on the recording medium 26 of the electronic camera 10. The data recording structure is compliant with DCF as described above. FIGS. 8A and BB illustrate description contents of group management data items (GRP0001.XML, GP0002.XML) in the data recording structure of FIG. 7. FIG. 9 illustrates a data recording structure recorded on the data recording medium 42 of the data storage apparatus 28 before the data storing program is operated. In the data recording structure, image data is recorded in the folder (“060610150130”) under the IMAGE folder, and group management data is recorded in the GROUP_DAT folder. Another directory structure can be adopted as a matter of course within the scope of the present invention. FIG. 10 illustrates description contents of the group management data item (GRP0001.XML) in the data recording structure illustrated in FIG. 9. As described above, in the second embodiment, the group management data items recorded on the data recording medium 42 of the data storage apparatus 28 are also described in XML. However, the language describing the group management data items recorded on the data recording medium 42 of the data storage apparatus 28 is not limited to XML, but the group management data items may be described by another language.

In this case, the data storage apparatus 28 searches the data recording structure recorded on the recording medium 26 of the electronic camera 10, and determines that group management data items (GRP0001.XML, GRP0002.XML) are recorded therein (corresponding to Step S30). Next, the data storage apparatus 28 obtains a group identifier (uuid element: 745fc481-78d4-8a45-5632-f2a87Safad69) from the GRP0001.XML (corresponding to Step S32). The data storage apparatus 28 determines whether any group associated with the obtained group identifier is recorded on the data recording medium 42 of the data storage apparatus 28 (corresponding to Step S34). In this example, as illustrated in FIGS. 9 and 10, the group identifier (uuid element: 745fc481-78d4-8a45-5632-f2a875afad69) of the group management data item (GRP0001.XML) recorded on the data recording medium 42 of the data storage apparatus 28 matches the obtained group identifier. Therefore, the data storage apparatus 28 determines that a group associated with the group identifier has already been recorded on the data recording medium 42 of the data storage apparatus 28 (corresponding to YES of Step S34). The data storage apparatus 28 additionally writes information of images to be recorded in the group management data item (GRP0001.XML) of the data recording medium 42 of the data storage apparatus 28 (corresponding to Step S38). As illustrated in FIG. 10, since the image information of the image data item P1010001.JPG has already been recorded in the group management data item (GRP0001.XML) of the data recording medium 42 of the data storage apparatus 28, image information to be added is an image information item of P1010002.JPG. Thereafter, the data storage apparatus 28 generates a folder “060612104500”, which is a folder to record image data, under the IMAGE folder. A folder is generated under the IMAGE folder each time data recording is performed by the data storage apparatus 28. Folders under the IMAGE folder are configured to have different folder names which do not overlap each other in the IMAGE folder, by using the current date and time, etc. Then, the data storage apparatus 28 records the image data item P1010002.JPG in the folder “060612104500” in the data recording medium 42 of the data storage apparatus 28 (corresponding to Step S40). Since the image data item P101001.JPG has already been recorded, recording of the image data item is not performed again.

When data recording concerning the group management data item (GRP0001.XML) has been finished, the data storage apparatus 28 determines whether image data items of all the groups have been recorded (corresponding to Step S42). In this example, since another group management data item (GRP0002.XML) is recorded on the recording medium 26 of the electronic camera 10, the data storage apparatus 28 changes the group to be recorded (corresponding to Step S44), and repeats the above processing.

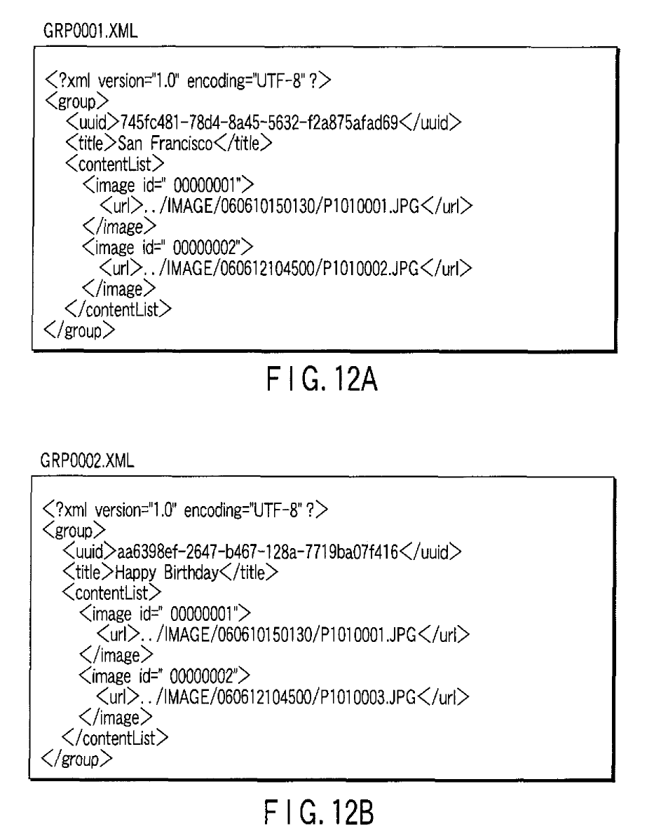

The data storage apparatus 28 analyzes GRP0002.XML, and obtains the group identifier (uuid element: aa6398ef-2647-b467-128a-7719ba07f416) thereof (corresponding to Step S32). The data storage apparatus 28 determines whether any group associated with the obtained group identifier is recorded on the data recording medium 42 of the data storage apparatus 28 (corresponding to Step S34). In this example, the data storage apparatus 28 determines that no group management data item having a group identifier matching the obtained group identifier is recorded on the data recording medium 42 (branched to NO of Step S34). The data storage apparatus 28 generates a new group management data item (GRP0002.XML) in the data recording medium 42 thereof, and associates it with the obtained group identifier (uuid element: aa6398ef-2647-b467-128a-7719ba07f416) (specifically, the group identifier is written in GRP0002.XML) (corresponding to Step S36). Next, the data storage apparatus 28 additionally writes image information of images to be recorded on the data recording medium 42 of the data storage apparatus 28 in the group management data item (GRP0002.XML) (corresponding to Step S38). Image information items to be additionally written are image information items of P1010001.JPG, and P1010003.JPG. FIG. 12B illustrates description contents of the group management data item (GRP0002.XML) recorded on the data recording medium 42 of the data storage apparatus 28 when the additional writing has been finished. Next, the data storage apparatus 28 records the image data item (P1010003.JPG) in the folder “060612104500” under the IMAGE folder of the data recording medium 42 (corresponding to Step S40). FIG. 11 illustrates a data recording structure of the data recording medium 42 of the data storage apparatus 28 when such data recording is finished.

It goes without saying that content data such as image data stored in the data recording medium 42 by the data storage apparatus 28 can be classified in the data storage apparatus 28 by the same method as that in the first embodiment.

Further, in step S42, it is determined whether image data items of all the groups have been processed or not. However, it is not always necessary to store content data of all the groups in the data storage apparatus 28, but only groups designated by the user may be selectively stored therein.

The present invention explained above based on the embodiments is not limited to the above embodiments, but can be variously modified or applied as a matter of course within the scope of the present invention.

For example, generation and recording of group identifiers and processing other than classification based on group identifiers may be performed by manual operation by the user.

Further, as a matter of course, the data storage apparatus 28 can directly classify and store content data from the recording medium 26 removed from the electronic camera 10, by a mechanism of reading recording media provided in the data storage apparatus 28.

Furthermore, the above functions can be realized by supplying software programs (in particular, the above-mentioned “data processing program” and “data storing program”, although not limited to them) which realize the functions of the above embodiments to a computer, and executing the programs by the computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data processing apparatus which manages a plurality of content data items as one or more groups, comprising:
an ID assigning section which provides an ID to the group; and
a group management data generating section which generates a group management data item including at least an association information item between the content data items and the group and the ID.

2. A data processing apparatus according to claim 1, wherein
the ID includes an identification data item which is generated separately from a group name of the group, set for each group, and is different from group identifiers of other groups.

3. A data storage apparatus which obtains and stores content data items in groups from a data processing apparatus managing a plurality of data items as one or more groups, comprising:
a storing section which stores data;
an ID obtaining section which obtains an ID of a group to be obtained from the data processing apparatus;
a determining section which compares the ID obtained by the ID obtaining section with IDs of groups stored in the storing section, and determines whether same group as the group to be obtained from the data processing apparatus is stored in the storing section; and
a control section which controls obtaining of the group from the data processing apparatus and storing of the group in the storing section, according to a result of determination by the determining section.

4. A data storage apparatus according to claim 3, wherein
the control section performs control to update the group stored in the storing section, when the determining section determines that the same group as the group to be obtained is stored in the storing section.

5. A data storage apparatus according to claim 4, wherein
the control section obtains only content data items included in the group and not stored in the storing section from the data processing apparatus, and additionally stores the content data items in the storing section, and performs control to additionally write information of the additionally stored content data items on the group management data item which is stored in the storing section and manages the group, when the determining section determines that the same group as the group to be obtained is stored in the storing section.

6. A data storing apparatus according to claim 3, wherein
the control section obtains the group as a new group from the data processing apparatus and performs control to store the group in the storing section, when the determining section determines that the same group as the group to be obtained is not stored in the storing section.

7. A data processing system comprising:
a data processing apparatus which manages a plurality of content data items as one or more groups; and
a data storage apparatus which obtains and stores content data items in groups from the data processing apparatus,
wherein
the data processing apparatus includes:
an ID assigning section which assigns an ID to the group, and
a group management data generating section which generates a group management data item including at least association information between the content data items and the group and the ID; and
the data storage apparatus includes:
a storing section which stores data;
an ID obtaining section which obtains an ID of a group to be obtained from the data processing apparatus;
a determining section which compares the ID obtained by the ID obtaining section with IDs of groups stored in the storing section, and determines whether same group as the group to be obtained from the data processing apparatus is stored in the storing section; and
a control section which controls obtaining of the group from the data processing apparatus and storing of the group in the storing section, according to a result of determination by the determining section.

8. A data processing method which allows a computer to manage a plurality of content data items as one or more groups, comprising:
causing the computer to generate IDs for the respective groups; and
causing the computer to generate group management data items including at least association information between the content data items and the relevant group, and the ID.

9. A data storing method which allows a computer to obtain and store content data items in groups from a data processing apparatus managing a plurality of content data items as one or more groups, comprising:
causing the computer to obtain an ID of a group to be obtained from the data processing apparatus;
causing the computer to compare the ID with IDs of groups stored in the storing section which the computer manages, and determine whether same group as the group to be obtained from the data processing apparatus is stored in the storing section; and
causing the computer to control obtaining of the group from the data processing apparatus and storing of the group in the storing section, according to a result of determination.
